(19) United States
(12) Patent Application Publication
(10) Pub. No.: US 2017/0070763 A1
(43) Pub. Date: Mar. 9, 2017

(54) APPARATUS FOR CONTROLLING COPYING OF BROADCAST CONTENT AND METHOD FOR RECORDING AND PLAYING BACK BROADCAST CONTENT USING THE SAME

(71) Applicant: ELECTRONICS AND TELECOMMUNICATIONS RESEARCH INSTITUTE, Daejeon (KR)

(72) Inventor: Han-Seung KOO, Daejeon (KR)

(73) Assignee: ELECTRONICS AND TELECOMMUNICATIONS RESEARCH INSTITUTE, Daejeon (KR)

(21) Appl. No.: 15/254,140

(22) Filed: Sep. 1, 2016

(30) Foreign Application Priority Data
Sep. 7, 2015 (KR) 10-2015-0126349
Jun. 28, 2016 (KR) 10-2016-0080702

(51) Int. Cl. H04N 21/266; H04N 21/4627; H04N 21/2347; H04N 21/254

(52) U.S. Cl. CPC H04N 21/266; H04N 21/2541; H04N 21/4627; H04N 21/2347; H04N 21/26613

(57) ABSTRACT

Disclosed herein are an apparatus for controlling copying of broadcast content and a method for recording and playing back broadcast content using the apparatus. The broadcast content copying control apparatus includes a communication unit for receiving a request for recording of broadcast content from a DRM client, and receiving content management information (CMI) corresponding to the broadcast content from a DMCD server, a security package configuration unit for configuring a DMCD security package using the CMI, a content management unit for recording the broadcast content based on recording permission information included in the CMI, and an encryption/decryption unit for encrypting the broadcast content, wherein the communication unit transmits recording result information to the DRM client, wherein the recording result information includes at least one of recording status information of the broadcast content, copy control information (CCI) corresponding to the broadcast content, and the CMI.

### CROSS REFERENCE TO RELATED APPLICATIONS

This application claims the benefit of Korean Patent Application Nos. 10-2015-0126349, filed Sep. 7, 2015 and 10-2016-0080702, filed Jun. 28, 2016, which are hereby incorporated by reference in their entirety into this application.

### BACKGROUND OF THE INVENTION

1. Technical Field

The present invention relates generally to technology for recording and playing back broadcast content, which is performed by an apparatus for controlling the copying of broadcast content and, more particularly, to Downloadable Multi-Conditional Access/Digital Rights Management (Downloadable Multi-CA/DRM: DMCD) technology, which can control the copying of broadcast content between an Authorized Service Domain (ASD) host and a non-ASD host.

2. Description of the Related Art

In paid digital broadcasting services, Multiple Service Operators (MSOs) may control the distribution of broadcast content through broadcast receiving terminals using Authorized Service Domain (ASD) technology.

Conventional Digital Rights Management (DRM) technology authenticates and authorizes each user or each terminal. However, ASD technology authenticates and authorizes either a plurality of terminals possessed by a specific user or the members of a single family and their terminals. By means of this, ASD technology may control the copying of broadcast content between ASD terminals.

However, conventional ASD technology merely defines conceptual and functional upper levels, but does not clearly define in detail which structure is used and which scheme is operated to control the copying of broadcast content. Further, the conventional ASD technology may conceptually control the copying of broadcast content only between ASD hosts.

Therefore, the development of technology related to a Downloadable Multi-CA/DRM (DMCD) host that is capable of controlling the copying of broadcast content between an ASD host and a non-ASD host is required.

In connection with this, Korean Patent Application Publication No. 10-2009-0041262 discloses a technology related to “Broadcast receiving apparatus for fair-use of broadcast, and method for recording and reproducing a broadcast in that.”

### SUMMARY OF THE INVENTION

Accordingly, the present invention has been made keeping in mind the above problems occurring in the prior art, and an object of the present invention is to control the copying of broadcast content even when making a connection between an ASD host and a non-ASD host.

Another object of the present invention is to protect the rights and profits of a broadcast content provider by preventing the illegal use of broadcast content.

A further object of the present invention is to prevent the illegal distribution and copying of broadcast content.

In accordance with an aspect of the present invention to accomplish the above objects, there is provided a broadcast content recording method performed by an apparatus for controlling copying of broadcast content, including receiving a request for recording of broadcast content from a Digital Rights Management (DRM) client, requesting content management information (CMI) corresponding to the broadcast content from a Downloadable Multi-Conditional Access (Multi-CA)/DRM (DMCD) server, configuring a DMCD security package using the content management information (CMI) received from the DMCD server, operating an encryption/decryption unit to encrypt the broadcast content, recording the encrypted broadcast content based on recording permission information included in the content management information (CMI), and transmitting recording result information to the DRM client, wherein the recording result information includes at least one of recording status information of the broadcast content, copy control information (CCI) corresponding to the broadcast content, and the content management information (CMI).

Configuring the DMCD security package may be configured to operate a timer to correspond to the content management information (CMI).

When a time set in the timer is expired, use of the broadcast content may be terminated.

The broadcast content recording method may further include, when the use of the broadcast content is terminated, storing the DMCD security package in secure storage in a form of a persistent security package.

Configuring the DMCD security package may be configured to authenticate the content management information (CMI), and thereafter configure the DMCD security package.

The DMCD security package may include at least one of an encryption key required to encrypt the broadcast content, the copy control information (CCI), and the content management information (CMI).

In accordance with another aspect of the present invention to accomplish the above object, there is provided a broadcast content playback method performed by an apparatus for controlling copying of broadcast content, including receiving a request for playback of broadcast content from a DRM client, loading a persistent security package corresponding to the broadcast content in a form of a DMCD security package, decrypting the DMCD security package, playing back the broadcast content in accordance with copy control information (CCI) and content management information (CMI), which correspond to the decrypted DMCD security package, and transmitting playback information of the broadcast content to the DRM client.

Loading the persistent security package in the form of the DMCD security package may be configured to operate a timer to correspond to the content management information (CMI).

The broadcast content playback method may further include, when a time set in the timer is expired and then use of the broadcast content is terminated, storing the DMCD security package in secure storage in a form of the persistent security package.

Storing the DMCD security package in the secure storage in the form of the persistent security package may be configured to update information about the broadcast content and thereafter store the DMCD security package in the form of the persistent security package.

The broadcast content playback method may further include, after receiving the request for playback of the broadcast content, authenticating the persistent security package.

In accordance with a further aspect of the present invention to accomplish the above object, there is provided an apparatus for controlling copying of broadcast content, including a communication unit for receiving a request for recording of broadcast content from a DRM client, and receiving content management information (CMI) corresponding to the broadcast content from a DMCD server, a security package configuration unit for configuring a DMCD security package using the content management information (CMI), a content management unit for recording the broadcast content based on recording permission information included in the content management information (CMI), and an encryption/decryption unit for encrypting the broadcast content, wherein the communication unit transmits recording result information to the DRM client, wherein the recording result information includes at least one of recording status information of the broadcast content, copy control information (CCI) corresponding to the broadcast content, and the content management information (CMI).

The apparatus may further include secure storage for, when use of the broadcast content is terminated, storing the DMCD security package in a form of a persistent security package.

The security package configuration unit may be configured to, when a request for playback of the broadcast content is received from the DRM client, load the persistent security package corresponding to the broadcast content in a form of the DMCD security package.

The security package configuration unit may authenticate the persistent security package after receiving the request for playback of the broadcast content.

The encryption/decryption unit may decrypt the loaded DMCD security package, and the content management unit may play back the broadcast content in accordance with the copy control information (CCI) and the content management information (CMI), which correspond to the decrypted DMCD security package.

The communication unit may transmit playback information of the broadcast content to the DRM client.

The secure storage may be configured to, when use of the broadcast content is terminated, update information about the broadcast content and thereafter store the DMCD security package in the form of the persistent security package.

The security package configuration unit may operate a timer to correspond to the content management information (CMI), and terminate use of the broadcast content when a time set in the timer is expired.

The DMCD security package may include at least one of an encryption key required to encrypt the broadcast content, the copy control information (CCI), and the content management information (CMI).

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram schematically showing an environment to which an apparatus for controlling the copying of broadcast content according to an embodiment of the present invention is applied;

FIG. 2 is a block diagram showing the configuration of an apparatus for controlling the copying of broadcast content according to an embodiment of the present invention;

FIG. 3 is a flowchart illustrating a broadcast content recording method according to an embodiment of the present invention;

FIG. 4 is a flowchart illustrating a broadcast content playback method according to an embodiment of the present invention;

FIG. 5 is a configuration diagram illustrating the structure and operating method of the broadcast content copying control apparatus according to an embodiment of the present invention; and

FIG. 6 is a block diagram showing a computer system according to an embodiment of the present invention.

### DESCRIPTION OF THE PREFERRED EMBODIMENTS

The present invention will be described in detail below with reference to the accompanying drawings. Repeated descriptions and descriptions of known functions and configurations which have been deemed to make the gist of the present invention unnecessarily obscure will be omitted below. The embodiments of the present invention are intended to fully describe the present invention to a person having ordinary knowledge in the art to which the present invention pertains. Accordingly, the shapes, sizes, etc. of components in the drawings may be exaggerated to make the description clearer.

Hereinafter, preferred embodiments of the present invention will be described in detail with reference to the attached drawings.

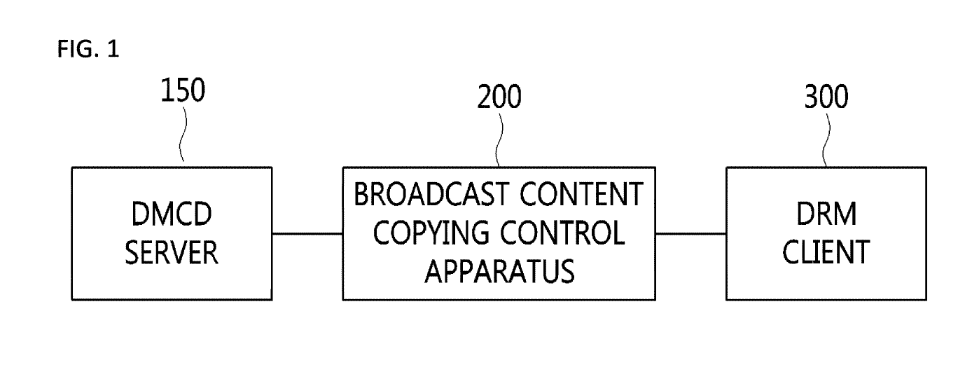

FIG. 1 is a diagram schematically showing an environment to which an apparatus for controlling the copying of broadcast content according to an embodiment of the present invention is applied.

As shown in FIG. 1, an apparatus 200 for controlling the copying of broadcast content (hereinafter referred to as a “broadcast content copying control apparatus 200”) communicates with a Downloadable Multi-CA/DRM (DMCD) server 100.

The broadcast content copying control apparatus 200 may receive at least one of copy control information (CCI) and DMCD flag information, which correspond to broadcast content, from an Entitlement Control Message (ECM) sent through an in-band broadcast channel.

Further, the broadcast content copying control apparatus 200 requests content management information (CMI), corresponding to the broadcast content that is requested to be recorded, from the DMCD server 100, and receives the content management information (CMI) from the DMCD server 100. Here, the DMCD server 100 may be a server for providing a DMCD service.

Further, the broadcast content copying control apparatus 200 receives a request for the recording of broadcast content or the playback of broadcast content from a DRM client 300.

When receiving the request for the recording of broadcast content, the broadcast content copying control apparatus 200 configures a DMCD security package using the content management information (CMI) and records the broadcast content. Further, the broadcast content copying control apparatus 200 may transmit information about the recording results to the DRM client 300.

Meanwhile, when receiving the request for the playback of broadcast content from the DRM client 300, the broadcast content copying control apparatus 200 loads the DMCD security package and then plays back the broadcast content. Further, the broadcast content copying control apparatus 200 transmits information about the playback of broadcast content to the DRM client 300.

Hereinafter, the configuration of the broadcast content copying control apparatus according to an embodiment of the present invention will be described in detail.

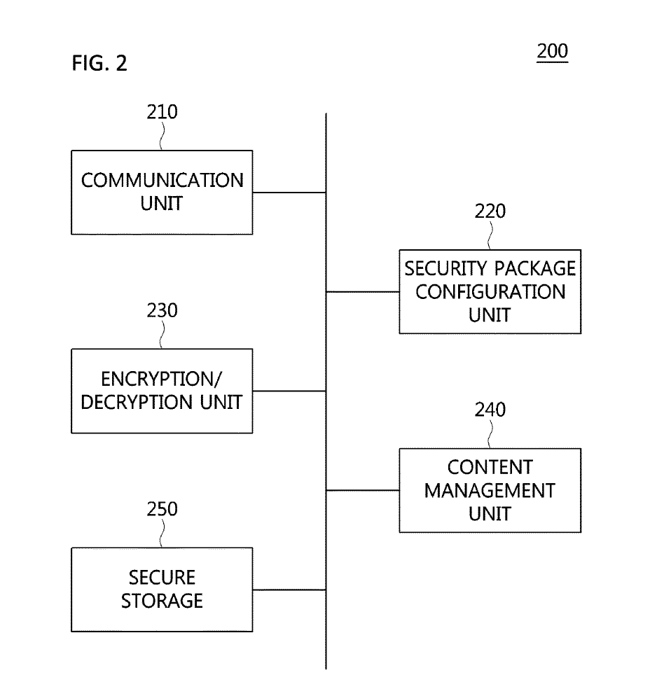

FIG. 2 is a block diagram showing the configuration of a broadcast content copying control apparatus according to an embodiment of the present invention.

As shown in FIG. 2, the broadcast content copying control apparatus 200 includes a communication unit 210, a security package configuration unit 220, an encryption/decryption unit 230, a content management unit 240, and secure storage 250.

First, the communication unit 210 communicates with at least one of a DMCD server and a DRM client.

The communication unit 210 may receive a request for the recording of broadcast content from the DRM client, and may receive content management information (CMI) corresponding to the broadcast content from the DMCD server. Further, the communication unit 210 transmits recording result information, including at least one of information about the recording status of broadcast content, copy control information (CCI) corresponding to the broadcast content, and the content management information (CMI), to the DRM client.

Further, the communication unit 210 may receive a request for the playback of broadcast content from the DRM client and transmit the playback information of the broadcast content to the DRM client.

Next, the security package configuration unit 220 configures a DMCD security package using the content management information (CMI). Further, when a request for the playback of broadcast content is received from the DRM client, the security package configuration unit 220 loads a persistent security package corresponding to the broadcast content in the form of a DMCD security package.

Also, after receiving the request for the playback of broadcast content, the security package configuration unit 220 may authenticate the persistent security package. Furthermore, the security package configuration unit 220 may operate a timer to correspond to the content management information (CMI), and may terminate the use of the broadcast content when the time set in the timer has expired.

The encryption/decryption unit 230 encrypts the broadcast content to be recorded during a procedure for recording the broadcast content. Further, the encryption/decryption unit 230 may decrypt the broadcast content to be played back during a procedure for playing back the broadcast content.

The content management unit 240 records the broadcast content based on the recording permission information included in the content management information (CMI). Further, the content management unit 240 may play back the broadcast content in accordance with the copy control information (CCI) and the content management information (CMI), which correspond to the decrypted DMCD security package.

Finally, the secure storage 250 stores the DMCD security package in the form of a persistent security package when the use of the broadcast content is terminated. Here, the secure storage 250 may update the information about the broadcast content and thereafter store the DMCD security package in the form of a persistent security package.

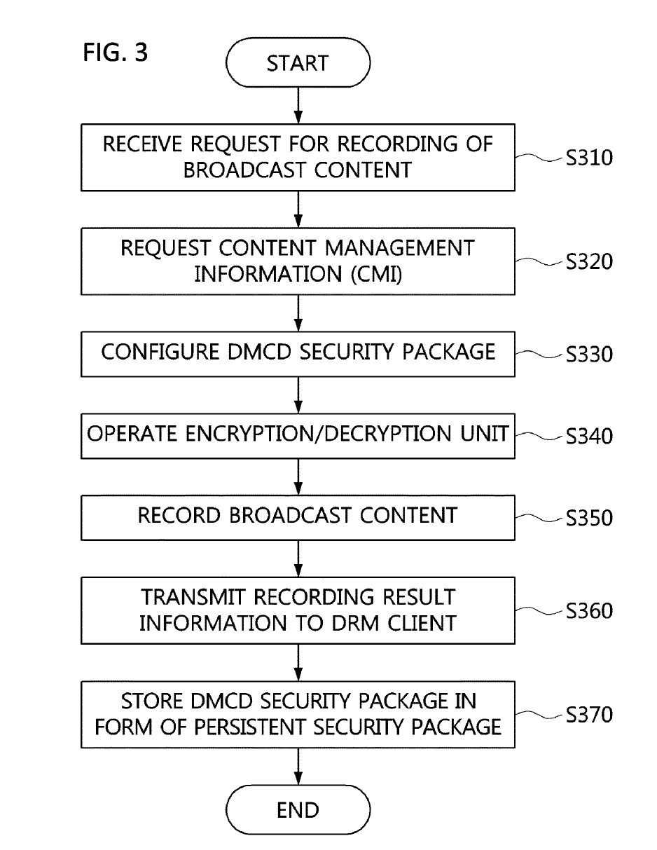

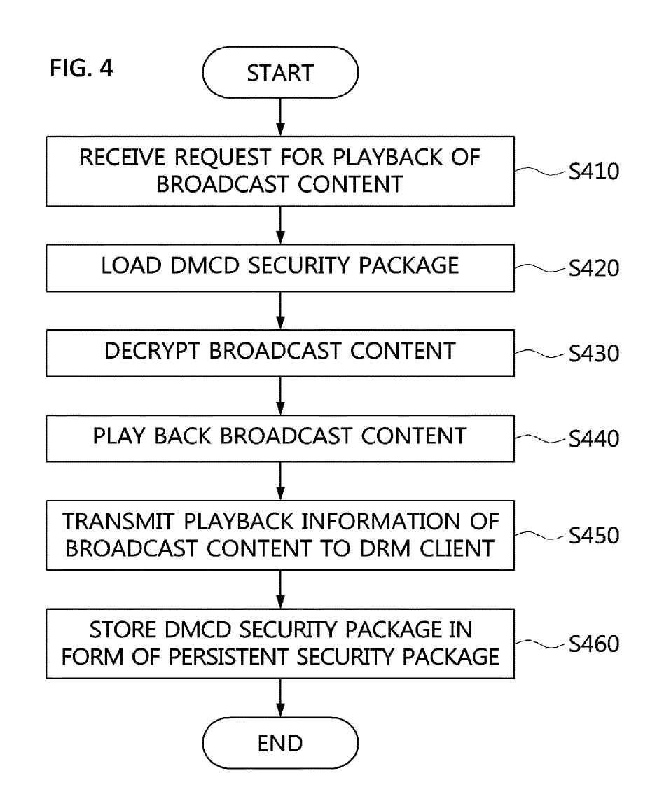

Hereinafter, a broadcast content recording method and a broadcast content playback method performed by the broadcast content copying control apparatus according to an embodiment of the present invention will be described in detail with reference to FIGS. 3 and 4.

FIG. 3 is a flowchart illustrating a broadcast content recording method according to an embodiment of the present invention.

First, the broadcast content copying control apparatus 200 receives a request for the recording of broadcast content from a DRM client at step S310.

The broadcast content copying control apparatus 200 receives a request for the recording of broadcast content that is delivered through a broadcast channel from the DRM client. The request for the recording of the broadcast content includes a broadcast content identification value, and the broadcast content copying control apparatus 200 prepares the recording of broadcast content corresponding to the broadcast content identification value. At this time, the DRM client may be made aware of the broadcast content identification value in advance through the sharing of program information.

Further, the broadcast content copying control apparatus 200 may receive an encrypted recording request from the DRM client. The DRM client may encrypt the recording request using an encryption key previously shared with the broadcast content copying control apparatus 200.

Furthermore, the broadcast content copying control apparatus 200 may authenticate the recording request using a Hash-based Message Authentication Code (HMAC) scheme.

Next, the broadcast content copying control apparatus 200 requests content management information (CMI) corresponding to the broadcast content from a DMCD server at step S320.

Here, the broadcast content copying control apparatus 200 may check the setting of the value of the DMCD flag of the broadcast content corresponding to the recording request, and may then perform step S320.

The DMCD flag may be received from an ECM that is sent through an in-band broadcast channel before the broadcast content copying control apparatus 200 performs step S310. Here, the broadcast content copying control apparatus 200 may receive copy control information (CCI), together with the DMCD flag, from the ECM.

The value of the DMCD flag may be set to 0 or 1. When the value of the DMCD flag is set to 1, the broadcast content copying control apparatus 200 may perform step S320, whereas when the value of the DMCD flag is set to 0, the broadcast content copying control apparatus 200 may terminate the broadcast content recording procedure. For the convenience of description, the case where the value of the DMCD flag is set to 0 or 1 has been described, but the value of the DMCD flag is not limited thereto.

At step S320, the content management information (CMI), received by the broadcast content copying control apparatus 200 from the DMCD server, may include at least one of a DMCD security type, a DMCD client id, a DMCD host secure processor id, a Conditional Access System (CAS) secure module id, a DMCD content id, content information (Content info), source analog information, source unencrypted information, DMCD CCI, usage rights enabled information, DMCD timestamp, and other data (private data).

The term “DMCD security type” in the content management information (CMI) means the type of CAS used, such as an integrated CAS, a CableCARD, a Downloadable CAS (DCAS), and a Renewable CAS (RCAS). Further, the DMCD client id denotes the value of a DMCD client id that is unique all over the world, and may be a value assigned from a third-party authentication institution, such as an Industry License Authority (ILA).

The term “DMCD content id” may mean a value obtained by applying a hash function to the DMCD client id, the DMCD host secure processor id, a DMCD content key, and the DMCD timestamp. As the hash function, a Secure Hash Algorithm 1 (SHA-1) may be used, but the hash function of the invention is not limited thereto.

The term “content information (Content info)” may include a security level, a cipher type, a content key client, and a content key system. The term “security level” may mean a relative security level, and may be a value determined by the broadcast content copying control apparatus 200. The term “cipher type” means the type of encryption algorithm, such as triple Data Encryption Standard (3DES) or Advanced Encryption Standard-129 (AES-129), used when content and a content key are encrypted.

The term “content key client” denotes a content key value used to encrypt broadcast content, and may be generally encrypted and stored using a scheme, such as the Rivest-Shamir-Adleman (RSA) public key scheme of the broadcast content copying control apparatus 200. The term “content key system” may mean a content key value used to encrypt broadcast content, and may be encrypted and stored using a scheme such as the RSA public key of the DMCD system. Further, the term “content key system” is used when there is a need to reconstruct a content key in a headend.

The source analog information is set to 1 when the source of the broadcast content is analog, and the source unencrypted information is set to 1 when the source of the broadcast content is not encrypted. The term “DMCD CCI” denotes CCI to be applied when broadcast content is played back, and may be considered to have higher priority than those of CCI values that are set through other interfaces.

The term “usage rights enabled information” means that, when it is set to a value other than 0, additional usage limits are present in DMCD CCI, and may have parameter values for a DMCD archive count, a DMCD playback count, and a Multiple Service Operator (MSO) usage rule.

The term “DMCD archive count” means the number of times that broadcast content is copied after being recorded, and the initial value thereof is 0. The term “DMCD playback count” means the remaining number of times that broadcast content can be played back, and the initial value thereof may be 0xffff. Further, the term “MSO usage rule” may have parameter values for analog output, digital output, digital storage, usage count, window start, and window duration.

The term “analog output” denotes information indicating the type of analog output via which broadcast content may be copied, and may be set to any one of types including no analog output, local display, Standard Definition (SD) composite out, High Definition (HD) analog, and all analog outputs. Further, the term “digital output” denotes information indicating the type of digital output via which broadcast content may be copied, and may be set to any one of types including no digital output, IEEE-1394, Digital Video Interactive (DVI), High Definition Multimedia Interface (HDMI), Ethernet, Universal Serial Bus (USB), home Networking, Serial Advanced Technology Attachment (SATA), and all digital outputs.

Further, the term “digital storage” means information indicating the type of digital storage in which the storage of broadcast content is permitted, and may be set to at least one of types including DVD-R, DVD-VR, DVD-RAM, DVD-RW, HD-DVD, Blu-ray DVD, a local hard drive, an external hard drive, and all digital outputs.

The term “usage count” means the maximum allowable number of uses of the corresponding output type. For example, when the value of the usage count is 0xffff, it means that the number of uses is not limited.

The term “window start” is a value in seconds that indicates the point of time at which the use of the corresponding output type is permitted. For example, when the value of window start is set to 10, it means that the use of the corresponding output type is permitted starting 10 seconds after the reception of a security package.

The term “window duration” is a value in seconds that indicates the period during which the use of the corresponding output type is permitted. When the value of window duration is set to 3600, it means that the use of the corresponding output type is permitted for 3600 seconds after the time of window start.

Also, window duration may have sub-parameter values for a protection type and a protection type parameter. The term “protection type” may mean the type of protection method to be applied to the corresponding output type, and may correspond to passive, analog encryption, Copy Generation Management System-Analog (CGMS-A), Digital Transmission Content Protection (DTCP), DTCP over Internet Protocol (DTCP-IP), High-bandwidth Digital Content Protection (HDCP), constrained image, or Content Protection for Recordable Media (CPRM) type. Further, the term “protection type parameter” means a parameter value required to operate the protection type.

The term “DMCD timestamp” included in the content management information (CMI) means information about the time at which the CMI was issued, and the term “private data” may mean other types of data that have been determined to require a CMI issuer.

Referring back to FIG. 3, the broadcast content copying control apparatus 200, having received the CMI from the DMCD server, configures a DMCD security package using the CMI at step S330.

Here, the broadcast content copying control apparatus 200 may perform the authentication of the received CMI, and may thereafter perform step S330.

The DMCD security package may include at least one of K_{DMCD}, copy control information (CCI), DMCD flag, and content management information (CMI) values, which are required to encrypt broadcast content.

Further, the broadcast content copying control apparatus 200 operates a timer to correspond to the window start information of the content management information (CMI).

Next, the broadcast content copying control apparatus 200 operates the encryption/decryption unit so as to encrypt the broadcast content at step S340, and records the encrypted broadcast content based on the recording permission information included in the content management information (CMI) at step S350.

Further, the broadcast content copying control apparatus 200 may encrypt broadcast content that is broadcasted in real time through the encryption/decryption unit, and may record (store) the encrypted broadcast content. Here, the broadcast content copying control apparatus 200 may authenticate the DMCD security package, and may thereafter encrypt the broadcast content corresponding to the DMCD security package.

Then, the broadcast content copying control apparatus 200 transmits information about the recording results to the DRM client at step S360.

The broadcast content copying control apparatus 200 delivers the recording result information, the copy control information (CCI), and the content management information (CMI), which correspond to the recording request, to the DRM client. Here, the broadcast content copying control apparatus 200 may encrypt the recording result information, the copy control information (CCI), and the content management information (CMI) using an encryption key previously shared with the DRM client, and may transmit the encrypted information to the DRM client.

Further, the DRM client, having received the recording result information, the copy control information (CCI), and the content management information (CMI) from the broadcast content copying control apparatus 200, may perform authentication using a Keyed-Hash Message Authentication Code (HMAC) scheme.

Finally, the broadcast content copying control apparatus 200 stores the DMCD security package in the form of a persistent security package at step S370.

When the use of the broadcast content is terminated in response to the window duration value, the broadcast content copying control apparatus 200 stores the DMCD security package in the secure storage in the form of a persistent security package (PSP).

FIG. 4 is a flowchart illustrating a broadcast content playback method according to an embodiment of the present invention.

The broadcast content copying control apparatus 200 receives a request for the playback of broadcast content from a DRM client at step S410.

The broadcast content copying control apparatus 200 receives a request for the playback of broadcast content desired to be played back, among pieces of broadcast content that are previously stored, from the DRM client. In this case, the broadcast content playback request includes a broadcast content identification value, and the DRM client may be made aware of the broadcast content identification value in advance by sharing information about a broadcast program with the broadcast content copying control apparatus 200.

Further, the broadcast content playback request may be encrypted using an encryption key, which is shared in advance between the broadcast content copying control apparatus 200 and the DRM client, and the broadcast content copying control apparatus 200 may authenticate the broadcast content playback request using an HMAC scheme.

Then, the broadcast content copying control apparatus 200 loads the DMCD security package corresponding to the broadcast content requested to be played back at step S420.

The broadcast content copying control apparatus 200 determines whether the persistent security package (PSP) corresponding to the broadcast content requested to be played back is stored in the secure storage. If it is determined that the persistent security package (PSP) corresponding to the broadcast content is stored in the secure storage, the broadcast content copying control apparatus 200 loads the corresponding persistent security package (PSP) in the form of a DMCD security package.

At this time, the DMCD security package may include at least one of K_{DMCD}, copy control information (CCI), and content management information (CMI), which correspond to the broadcast content. Further, the broadcast content copying control apparatus 200 operates a timer based on the window start value included in the content management information (CMI).

Next, the broadcast content copying control apparatus 200 may authenticate the loaded DMCD security package. Here, the broadcast content copying control apparatus 200 may perform authentication using a public key scheme, such as an electronic signature.

Then, the broadcast content copying control apparatus 200 decrypts the broadcast content at step S430.

Here, the broadcast content copying control apparatus 200 may decrypt the broadcast content using K_{DMCD}, included in the DMCD security package, as a key. Further, the broadcast content copying control apparatus 200 may authenticate the DMCD security package using a Hash-based Message Authentication Code (HMAC) scheme.

Thereafter, the broadcast content copying control apparatus 200 plays back the broadcast content at step S440.

The broadcast content copying control apparatus 200 plays back the broadcast content in accordance with the copy control information (CCI) and the content management information (CMI).

Further, the broadcast content copying control apparatus 200 transmits the playback information (playback status) of the broadcast content to the DRM client at step S450.

Finally, when the use of the broadcast content is terminated, the broadcast content copying control apparatus 200 stores the DMCD security package in the form of a persistent security package (PSP) at step S460.

When the use of the broadcast content is terminated in response to the window duration value in the content management information (CMI), the broadcast content copying control apparatus 200 updates the information of the PSP corresponding to the broadcast content, and thereafter stores the PSP in the secure storage. At this time, the broadcast content copying control apparatus 200 may update information, such as the number of views, and may then store the updated information.

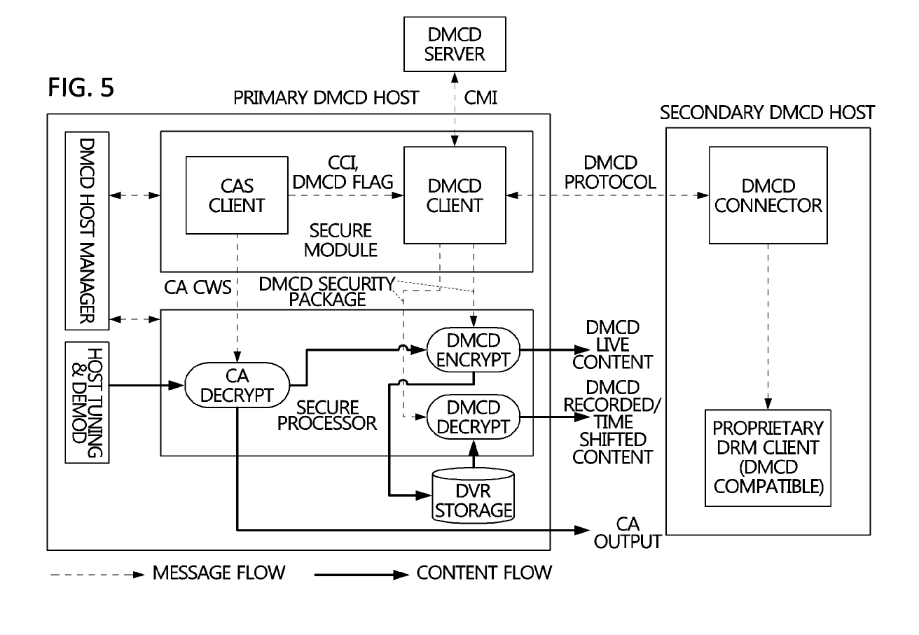

FIG. 5 is a configuration diagram illustrating the structure and operating method of the broadcast content copying control apparatus according to an embodiment of the present invention.

As shown in FIG. 5, a DMCD host may control the copying of broadcast content through a primary DMCD host and a secondary DMCD host. Here, the primary DMCD host may mean the broadcast content copying control apparatus 200 of FIG. 1, and the secondary DMCD host may mean the DRM client 300 of FIG. 1.

Further, the primary DMCD host has a direct interface with a headend, and the secondary DMCD host may receive both control information, required to protect broadcast content, and the broadcast content itself from the primary DMCD host.

The primary DMCD host receives content management information (CMI) from the DMCD server. Further, the primary DMCD host and the secondary DMCD host may communicate with each other via a DMCD protocol, and the secondary DMCD host may request the recording and playback of broadcast content from the primary DMCD host.

The primary DMCD host may be composed of a secure module and a secure processor for protecting the broadcast content. Further, the secure module includes a CAS client and a DMCD Client, and supports an interface function with the DMCD server, the secure processor, and a DMCD connector.

Here, the secure module may perform the same function as the communication unit 210 of the broadcast content copying control apparatus 200 shown in FIG. 2. In particular, the DMCD client may perform the function corresponding to the security package configuration unit 220 of FIG. 2.

Further, the secure processor includes a descrambler for a Conditional Access System (CAS) (CA Decrypt), a DMCD encryptor (DMCD Encrypt), and a DMCD decryptor (DMCD Decrypt). The secure processor may support an interface function with the secure module, DVR storage, and the secondary DMCD host.

Here, the descrambler for CAS (CA Decrypt), the DMCD encryptor (DMCD Encrypt), and the DMCD decryptor (DMCD Decrypt) perform functions substantially identical to those of the encryption/decryption unit 230 of FIG. 2. Further, a DMCD host manager may perform the function corresponding to that of the content management unit 240 of FIG. 2.

Furthermore, the secondary DMCD host may include a DMCD connector for supporting a DMCD function and a DRM client for a specific DRM solution.

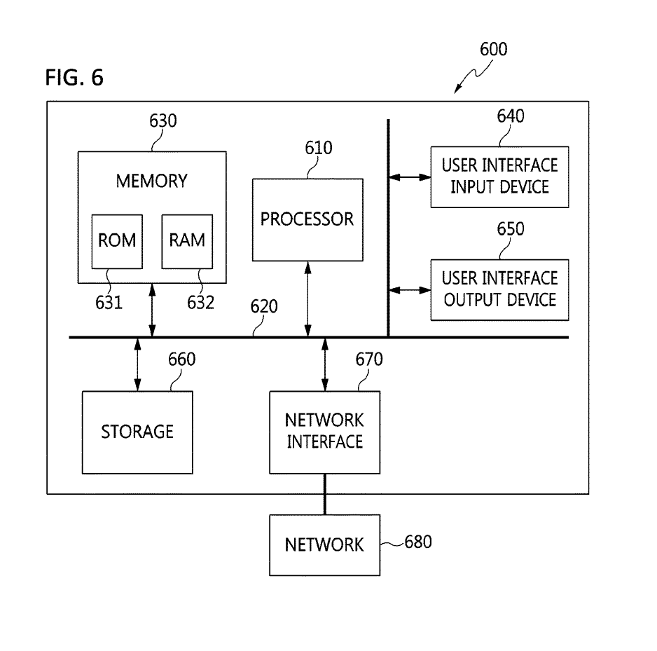

FIG. 6 is a block diagram showing a computer system according to an embodiment of the present invention.

Referring to FIG. 6, the embodiment of the present invention may be implemented in a computer system 600, such as a computer-readable storage medium. As shown in FIG. 6, the computer system 600 may include one or more processors 610, memory 630, a user interface input device 640, a user interface output device 650, and storage 660, which communicate with each other through a bus 620. The computer system 600 may further include a network interface 670 connected to a network 680. The processor 610 may be either a Central Processing Unit (CPU) or a semiconductor device for executing processing instructions stored in the memory 630 or the storage 660. Each of the memory 630 and the storage 660 may be any of various types of volatile or nonvolatile storage media. For example, the memory may include Read Only Memory (ROM) 631 or Random Access Memory (RAM) 632.

Therefore, the embodiments of the present invention may be implemented as a non-temporary computer-readable storage medium in which a computer-implemented method or computer-executable instructions are recorded. When the computer-readable instructions are executed by a processor, the instructions may perform the method according to at least one aspect of the present invention.

In accordance with the present invention, the copying of broadcast content may be controlled even when a connection is made between an ASD host and a non-ASD host.

Further, in accordance with the present invention, the rights and profits of a broadcast content provider may be protected by preventing the illegal use of broadcast content.

Furthermore, in accordance with the present invention, the illegal distribution and copying of broadcast content may be prevented.

As described above, in the broadcast content copying control apparatus, the broadcast content recording method, and the broadcast content playback method according to the present invention, the configurations and schemes in the above-described embodiments are not limitedly applied, and some or all of the above embodiments can be selectively combined and configured so that various modifications are possible.

What is claimed is:

1. A broadcast content recording method performed by an apparatus for controlling copying of broadcast content, comprising:
receiving a request for recording of broadcast content from a Digital Rights Management (DRM) client;
requesting content management information (CMI) corresponding to the broadcast content from a Downloadable Multi-Conditional Access (Multi-CA)/DRM (DMCD) server;
configuring a DMCD security package using the content management information (CMI) received from the DMCD server;
operating an encryption/decryption unit to encrypt the broadcast content;
recording the encrypted broadcast content based on recording permission information included in the content management information (CMI); and
transmitting recording result information to the DRM client, wherein the recording result information includes at least one of recording status information of the broadcast content, copy control information (CCI) corresponding to the broadcast content, and the content management information (CMI).

2. The broadcast content recording method of claim 1, wherein configuring the DMCD security package is configured to operate a timer to correspond to the content management information (CMI).

3. The broadcast content recording method of claim 2, wherein, when a time set in the timer is expired, use of the broadcast content is terminated.

4. The broadcast content recording method of claim 3, further comprising:
when the use of the broadcast content is terminated, storing the DMCD security package in secure storage in a form of a persistent security package.

5. The broadcast content recording method of claim 1, wherein configuring the DMCD security package is configured to authenticate the content management information (CMI), and thereafter configure the DMCD security package.

6. The broadcast content recording method of claim 1, wherein the DMCD security package comprises at least one of an encryption key required to encrypt the broadcast content, the copy control information (CCI), and the content management information (CMI).

7. A broadcast content playback method performed by an apparatus for controlling copying of broadcast content, comprising:
receiving a request for playback of broadcast content from a DRM client;
loading a persistent security package corresponding to the broadcast content in a form of a DMCD security package;
decrypting the DMCD security package;
playing back the broadcast content in accordance with copy control information (CCI) and content management information (CMI), which correspond to the decrypted DMCD security package; and
transmitting playback information of the broadcast content to the DRM client.

8. The broadcast content playback method of claim 7, wherein loading the persistent security package in the form of the DMCD security package is configured to operate a timer to correspond to the content management information (CMI).

9. The broadcast content playback method of claim 8, further comprising:
when a time set in the timer is expired and then use of the broadcast content is terminated, storing the DMCD security package in secure storage in a form of the persistent security package.

10. The broadcast content playback method of claim 9, wherein storing the DMCD security package in the secure storage in the form of the persistent security package is configured to update information about the broadcast content and thereafter store the DMCD security package in the form of the persistent security package.

11. The broadcast content playback method of claim 7, further comprising:
after receiving the request for playback of the broadcast content, authenticating the persistent security package.

12. An apparatus for controlling copying of broadcast content, comprising:
a communication unit for receiving a request for recording of broadcast content from a DRM client, and receiving content management information (CMI) corresponding to the broadcast content from a DMCD server;
a security package configuration unit for configuring a DMCD security package using the content management information (CMI);
a content management unit for recording the broadcast content based on recording permission information included in the content management information (CMI); and
an encryption/decryption unit for encrypting the broadcast content,
wherein the communication unit transmits recording result information to the DRM client, wherein the recording result information includes at least one of recording status information of the broadcast content, copy control information (CCI) corresponding to the broadcast content, and the content management information (CMI).

13. The apparatus of claim 12, further comprising:
secure storage for, when use of the broadcast content is terminated, storing the DMCD security package in a form of a persistent security package.

14. The apparatus of claim 13, wherein the security package configuration unit is configured to, when a request for playback of the broadcast content is received from the DRM client, load the persistent security package corresponding to the broadcast content in a form of the DMCD security package.

15. The apparatus of claim 14, wherein the security package configuration unit authenticates the persistent security package after receiving the request for playback of the broadcast content.

16. The apparatus of claim 14, wherein:
the encryption/decryption unit decrypts the loaded DMCD security package, and
the content management unit plays back the broadcast content in accordance with the copy control information (CCI) and the content management information (CMI), which correspond to the decrypted DMCD security package.

17. The apparatus of claim 16, wherein the communication unit transmits playback information of the broadcast content to the DRM client.

18. The apparatus of claim 16, wherein the secure storage is configured to, when use of the broadcast content is terminated, update information about the broadcast content and thereafter store the DMCD security package in the form of the persistent security package.

19. The apparatus of claim 18, wherein the security package configuration unit operates a timer to correspond to the content management information (CMI), and terminates use of the broadcast content when a time set in the timer is expired.

20. The apparatus of claim 12, wherein the DMCD security package comprises at least one of an encryption key required to encrypt the broadcast content, the copy control information (CCI), and the content management information (CMI).
